(19) United States
(12) Patent Application Publication
(10) Pub. No.: US 2021/0006384 A1
(43) Pub. Date: Jan. 7, 2021

(54) METHOD AND APPARATUS FOR CONTROLLING A DEACTIVATION TIMER OF AT LEAST ONE SECONDARY CELL IN A WIRELESS COMMUNICATION SYSTEM

(71) Applicant: GUANGDONG OPPO MOBILE TELECOMMUNICATIONS CORP., LTD., Dongguan, Guangdong (CN)

(72) Inventor: Cong SHI, Dongguan, Guangdong (CN)

(21) Appl. No.: 16/766,598

(22) PCT Filed: Nov. 27, 2018
(86) PCT No.: PCT/CN2018/117734

§ 371 Date: May 22, 2020

Related U.S. Application Data
(60) Provisional application No. 62/590,857, filed on Nov. 27, 2017.

(51) Int. Cl. H04L 5/00; H04W 76/38; H04W 72/04

(52) U.S. Cl. CPC H04L 5/0098; H04L 5/0032; H04W 72/042; H04L 5/0053; H04W 76/38; H04L 5/0078

(57) ABSTRACT

A method and an apparatus for controlling a deactivation timer of at least one secondary cell (SCell) in a wireless communication system are provided. The method for controlling the deactivation timer of the at least one SCell of a user equipment includes receiving a control indication through a physical downlink control channel (PDCCH) from a network node, wherein the control indication indicates a control of the deactivation timer of the at least one SCell, and controlling the deactivation timer of the at least one SCell according to the control indication.

### BACKGROUND OF DISCLOSURE

### 1. Field of Disclosure

The present disclosure relates to the field of communication systems, and more particularly, to a method and an apparatus for controlling a deactivation timer of at least one secondary cell (SCell) in a wireless communication system.

### 2. Description of Related Art

If a medium access control (MAC) entity is configured with one or more secondary cell (SCells), a network may activate and deactivate one or more configured SCells. The network activates and deactivates the one or more configured SCells by sending an activation/deactivation MAC control element (CE). Furthermore, the MAC entity maintains a deactivation timer per configured SCell (except the SCell configured with a physical uplink control channel (PUCCH), if any) and deactivates an associated SCell when the deactivation timer expires.

In new radio (NR) systems, technical specification group radio access network, working group 2 (TSG-RAN WG2), one of 3rd generation partnership project (3GPP) working groups, agrees to use the MAC CE to activate or deactivate the SCell in a RAN2 #99bis meeting, which is a baseline in long term evolution (LTE) systems.

There is a need to provide a new technical solution for controlling a deactivation timer of at least one SCell in a wireless communication system.

### SUMMARY

An object of the present disclosure is to propose a method and an apparatus for controlling a deactivation timer of at least one secondary cell (SCell) in a wireless communication system.

In a first aspect of the present disclosure, a user equipment for controlling a deactivation timer of at least one secondary cell (SCell) in a wireless communication system includes a memory, a transceiver, and a processor coupled to the memory and the transceiver. The processor is configured to control control the transceiver to receive a control indication through a physical downlink control channel (PDCCH) from a network node, wherein the control indication indicates control of the deactivation timer of the at least one SCell, and control the deactivation timer of the at least one SCell according to the control indication.

In a second aspect of the present disclosure, a method for controlling a deactivation timer of at least one secondary cell (SCell) of a user equipment includes receiving a control indication through a physical downlink control channel (PDCCH) from a network node, wherein the control indication indicates a control of the deactivation timer of the at least one SCell, and controlling the deactivation timer of the at least one SCell according to the control indication.

In a third aspect of the present disclosure, a network node for controlling a deactivation timer of at least one secondary cell (SCell) in a wireless communication system includes a memory, a transceiver, and a processor coupled to the memory and the transceiver. The processor is configured to control the transceiver to notify, to a user equipment, a control indication through a physical downlink control channel (PDCCH), wherein the control indication indicates a control of the deactivation timer of the at least one SCell, and control the deactivation timer of the at least one SCell according to the control indication.

In a forth aspect of the present disclosure, a method for controlling a deactivation timer of at least one secondary cell (SCell) of a network node includes notifying, to a user equipment, a control indication through a physical downlink control channel (PDCCH), wherein the control indication indicates control of the deactivation timer of the at least one SCell, and controlling the deactivation timer of the at least one SCell according to the control indication.

In a fifth aspect of the present disclosure, a non-transitory machine-readable storage medium has stored thereon instructions that, when executed by a computer, cause the computer to perform the above method.

In a sixth aspect of the present disclosure, a terminal device includes a processor and a memory configured to store a computer program. The processor is configured to execute the computer program stored in the memory to perform the above method.

In a seventh aspect of the present disclosure, a network node includes a processor and a memory configured to store a computer program. The processor is configured to execute the computer program stored in the memory to perform the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a user equipment and a network node for controlling a deactivation timer of at least one secondary cell (SCell) in a wireless communication system according to an embodiment of the present disclosure.

FIG. 2 is a flowchart illustrating a method for controlling a deactivation timer of at least one SCell of a user equipment according to an embodiment of the present disclosure.

FIG. 3 is a flowchart illustrating a method for controlling a deactivation timer of at least one SCell of a network node according to an embodiment of the present disclosure.

FIG. 4 is a schematic diagram illustrating a control of a deactivation timer of at least one SCell between a user equipment and a network node according to an embodiment of the present disclosure.

FIG. 5 is a schematic diagram of an activation method for a deactivation timer of at least one SCell between a user equipment and a network node according to an embodiment of the present disclosure.

FIG. 6 is a schematic diagram of an activation method for a deactivation timer of at least one SCell between a user equipment and a network node according to another embodiment of the present disclosure.

FIG. 7 is a schematic diagram of a deactivation method for a deactivation timer of at least one SCell between a user equipment and a network according to an embodiment of the present disclosure.

FIG. 8 is a schematic diagram of a deactivation method for a deactivation timer of at least one SCell between a user equipment and a network according to another embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

FIG. 1 illustrates that, in some embodiments, a user equipment (UE) 10 and a network node 20 control a deactivation timer of at least one secondary cell (SCell) in a wireless communication system according to an embodiment of the present disclosure. The UE 10 may include a processor 11, a memory 12 and a transceiver 13. The network node 20 may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) new radio (NR) Release 16 and beyond. UEs are communicated with each other directly via a sidelink interface such as a PC5 interface.

In some embodiments, the processor 11 is configured to control the transceiver 13 to receive a control indication through a physical downlink control channel (PDCCH) from the network node 20, wherein the control indication indicates control of the deactivation timer of the at least one SCell, and control the deactivation timer of the at least one SCell according to the control indication.

In some embodiments, the processor 21 is configured to control the transceiver 23 to notify, to the user equipment 10, a control indication through a PDCCH, wherein the control indication indicates control of the deactivation timer of the at least one SCell, and control the deactivation timer of the at least one SCell according to the control indication.

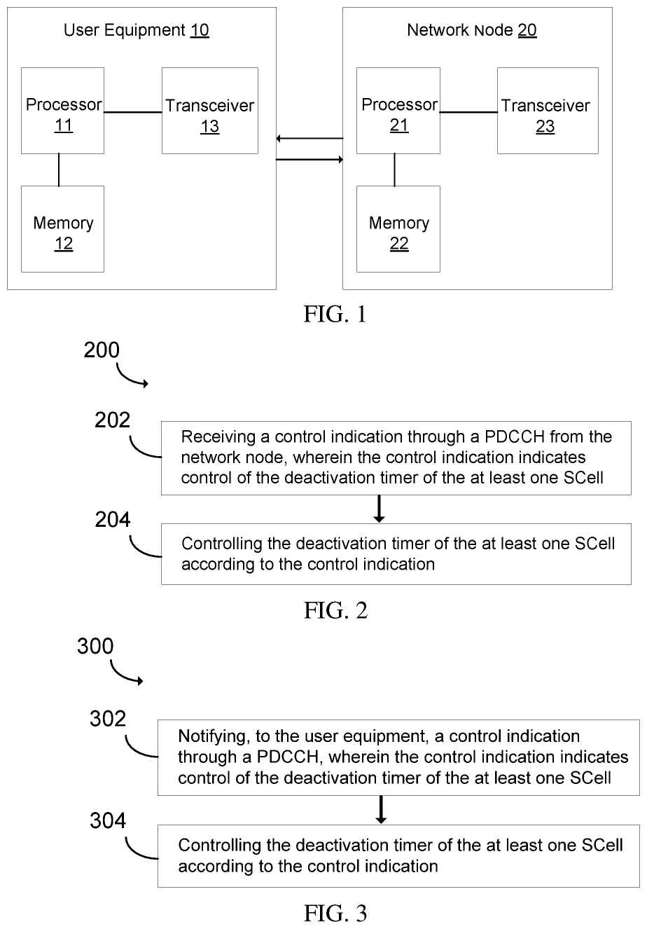

FIG. 2 illustrates a method 200 for controlling a deactivation timer of at least one SCell of the user equipment 10 according to an embodiment of the present disclosure. The method 200 includes: at block 202, receiving a control indication through a PDCCH from the network node 20, wherein the control indication indicates control of the deactivation timer of the at least one SCell, and at block 204, controlling the deactivation timer of the at least one SCell according to the control indication.

FIG. 3 illustrates a method 300 for controlling a deactivation timer of at least one SCell of the network node 20 according to an embodiment of the present disclosure. The method 300 includes: at block 302, notifying, to the user equipment 10, a control indication through a PDCCH, wherein the control indication indicates a control of the deactivation timer of the at least one SCell, and at block 304, controlling the deactivation timer of the at least one SCell according to the control indication.

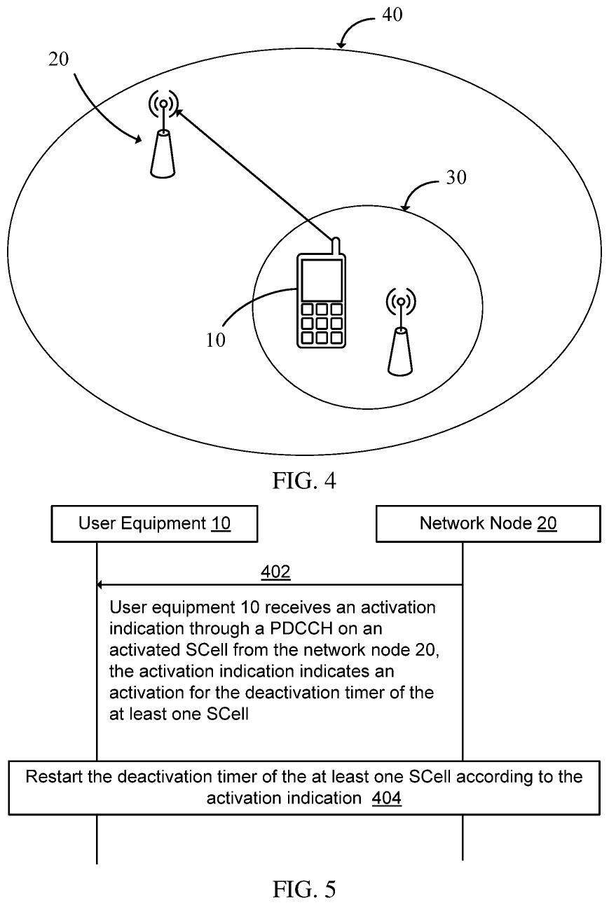

FIG. 4 illustrates that, in some embodiments, control of a deactivation timer of at least one SCell 30 between the user equipment 10 and the network node 20 according to an embodiment of the present disclosure is provided. The user equipment 10 may communicate with multiple cells that are managed by the network node 20 and may work on different frequencies. In order to increase a transmission bandwidth, one user may be served by multiple cells, and these cells may be covered by the network node 20. These cells include a primary cell (PCell) 40 and the at least one SCell 30. The PCell 40 can be a serving cell and can be in an active state. The PCell 40 can be handed over through a handover process. The user equipment 10 transmits and receives non-access stratum (NAS) information in the PCell 40, and a physical uplink control channel (PUCCH) is transmitted in the PCell 40.

In some embodiments, the control indication includes an activation indication and/or a deactivation indication. The PDCCH carries downlink control information (DCI) including the control indication.

The transceiver 13 is configured to receive information indicating a configuration of the at least one SCell from the network node 20. The processor 11 is configured to identify an activated SCell and/or a serving cell according to the information indicating the configuration of the at least one SCell from the network node 20.

In some embodiments, the transceiver 23 is configured to notify, to the user equipment 10, information indicating a configuration of the at least one SCell. The processor 21 is configured to identify an activated SCell and/or a serving cell according to the information indicating the configuration of the at least one SCell.

In some embodiments, the user equipment 10 is configured to receive information indicating the configuration of the at least one SCell 30 from the network node 20, such as the activated SCell and/or the serving cell, receive an activation/deactivation indication through a PDCCH from the network node 20, wherein the activation/deactivation indication indicates an activation/deactivation for the deactivation timer of the at least one SCell 30, and activates/deactivates the deactivation timer of the at least one SCell 30 according to the activation/deactivation indication.

In some embodiments, the network node 20 is configured to notify, to the user equipment 10, information indicating a configuration of the at least one SCell 30, such as the activated SCell and/or the serving cell, notify, to the user equipment 10, an activation/deactivation indication through a PDCCH, wherein the activation/deactivation indication indicates an activation/deactivation for the deactivation timer of the at least one SCell 30, and activates/deactivates the deactivation timer of the at least one SCell 30 according to the activation/deactivation indication.

FIG. 1 and FIG. 4 illustrate that, in some embodiments, the processor 11 or 21 is configured to control the deactivation timer of the at least one SCell 30 according to the DCI including the control indication.

FIG. 1 and FIG. 5 illustrate that, in some embodiments, an activation method 400 for the deactivation timer of the at least one SCell between the user equipment 10 and the network node 20 includes: at block 402, the transceiver 13 of the user equipment 10 receives an activation indication through the PDCCH on an activated SCell from the network node 20, the activation indication indicates an activation for the deactivation timer of the at least one SCell, and at block 404, the processor 11 of the user equipment 10 restarts the deactivation timer of the at least one SCell according to the activation indication. In other words, at block 402, the transceiver 23 of the network node 20 notifies, to the user equipment 10, an activation indication through the PDCCH on an activated SCell, the activation indication indicates an activation for the deactivation timer of the at least one SCell, and at block 404, the processor 21 of the network node 20 restarts the deactivation timer of the at least one SCell according to the activation indication. In some embodiments, the processor 11 or 21 is configured to restart the deactivation timer of the at least one SCell according to the DCI including the activation indication.

FIG. 1 and FIG. 6 illustrate that, in some embodiments, an activation method 500 for the deactivation timer of the at least one SCell between the user equipment 10 and the network node 20 includes: at block 502, the transceiver 13 of the user equipment 10 receives an activation indication through the PDCCH on a serving cell from the network node 20, the activation indication indicates an activation for the deactivation timer of the at least one SCell, and at block 504, the processor 11 of the user equipment 10 starts or restarts the deactivation timer of the at least one SCell according to the activation indication. In other words, at block 502, the transceiver 23 of the network node 20 notifies, to the user equipment 10, an activation indication through the PDCCH on a serving cell, the activation indication indicates an activation for the deactivation timer of the at least one SCell, and at block 504, the processor 21 of the network node 20 starts or restarts the deactivation timer of the at least one SCell according to the activation indication. In some embodiments, the processor 11 or 21 is configured to start or restart the deactivation timer of the at least one SCell according to the DCI including the activation indication.

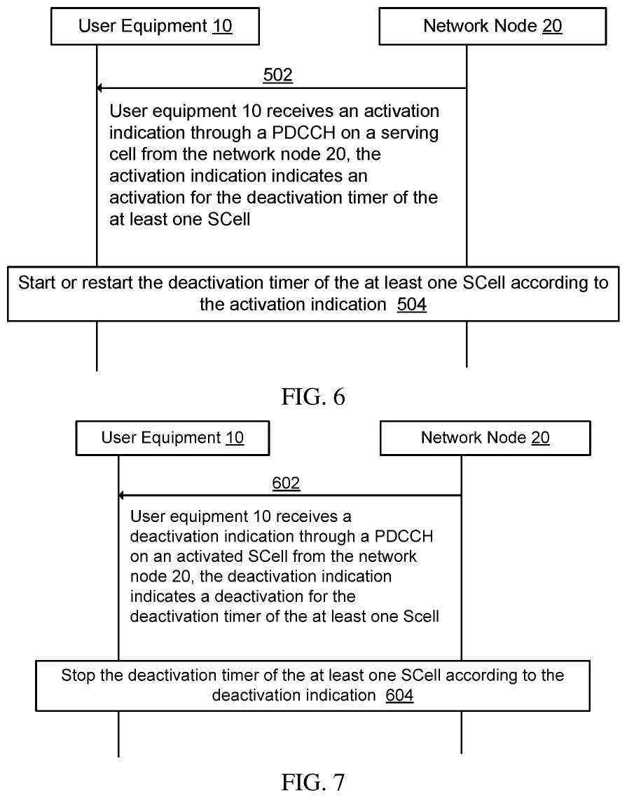

FIG. 1 and FIG. 7 illustrate that, in some embodiments, an deactivation method 600 for the deactivation timer of the at least one SCell between the user equipment 10 and the network node 20 includes: at block 602, the transceiver 13 of the user equipment 10 receives a deactivation indication through the PDCCH on an activated SCell from the network node 20, the activation indication indicates a deactivation for the deactivation timer of the at least one SCell, and at block 604, the processor 11 of the user equipment 10 stops the deactivation timer of the at least one SCell according to the deactivation indication. In other words, at block 602, the transceiver 23 of the network node 20 notifies, to the user equipment 10, a deactivation indication through the PDCCH on an activated SCell, the deactivation indication indicates a deactivation for the deactivation timer of the at least one SCell, and at block 604, the processor 21 of the network node 20 stops the deactivation timer of the at least one SCell according to the deactivation indication. In some embodiments, the processor 11 or 21 is configured to stop the deactivation timer of the at least one SCell according to the DCI including the deactivation indication.

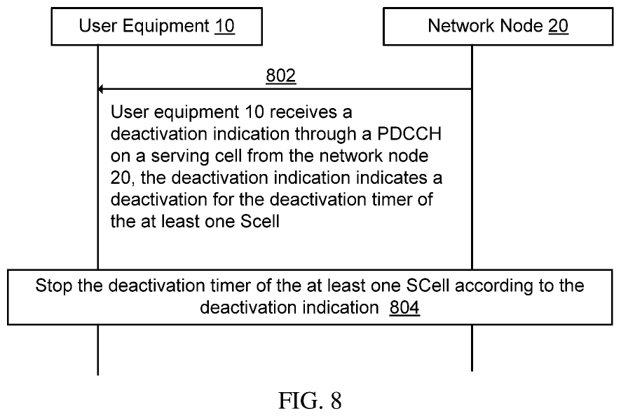

FIG. 1 and FIG. 8 illustrate that, in some embodiments, an deactivation method 800 for the deactivation timer of the at least one SCell between the user equipment 10 and the network node 20 includes: at block 802, the transceiver 13 of the user equipment 10 receives a deactivation indication through the PDCCH on a serving cell from the network node 20, the activation indication indicates a deactivation for the deactivation timer of the at least one SCell, and at block 804, the processor 11 of the user equipment 10 stops the deactivation timer of the at least one SCell according to the deactivation indication. In other words, at block 802, the transceiver 23 of the network node 20 notifies, to the user equipment 10, a deactivation indication through the PDCCH on a serving cell, the deactivation indication indicates a deactivation for the deactivation timer of the at least one SCell, and at block 804, the processor 21 of the network node 20 stops the deactivation timer of the at least one SCell according to the deactivation indication. In some embodiments, the processor 11 or 21 is configured to stop the deactivation timer of the at least one SCell according to the DCI including the deactivation indication.

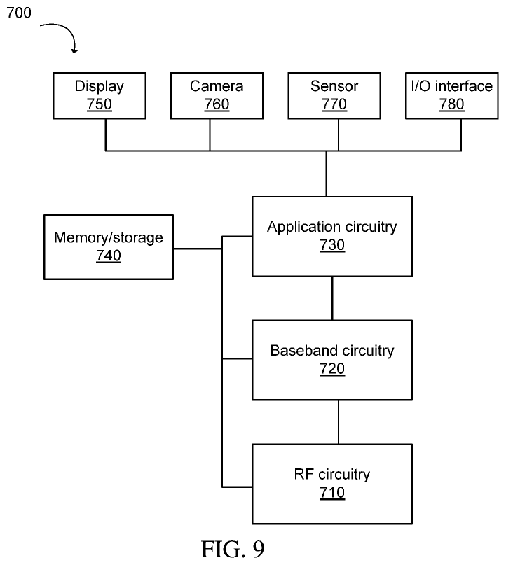

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

In the embodiment of the present disclosure, a method and an apparatus for controlling a deactivation timer of at least one secondary cell (SCell) in a wireless communication system are provided. The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A user equipment for controlling a deactivation timer of at least one secondary cell (SCell) in a wireless communication system, comprising:
a memory;
a transceiver; and
a processor coupled to the memory and the transceiver,
wherein the processor is configured to:
control the transceiver to receive a control indication through a physical downlink control channel (PDCCH) from a network node, wherein the control indication indicates control of the deactivation timer of the at least one SCell; and
control the deactivation timer of the at least one SCell according to the control indication.

2. The user equipment of claim 1, wherein the PDCCH carries downlink control information (DCI) comprising the control indication, the processor is configured to control the deactivation timer of the at least one SCell according to the DCI.

3. The user equipment of claim 1, wherein the control indication comprises an activation indication and/or a deactivation indication.

4. The user equipment of claim 3, wherein the transceiver is configured to receive information indicating a configuration of the at least one SCell from the network node, and the processor is configured to identify an activated SCell and/or a serving cell according to the information indicating the configuration of the at least one SCell from the network node.

5. (canceled)

6. The user equipment of claim 3, wherein the transceiver is configured to receive the activation indication through the PDCCH on an activated SCell from the network node, the activation indication indicates an activation for the deactivation timer of the at least one SCell, the processor is configured to restart the deactivation timer of the at least one SCell according to the activation indication, and the processor is configured to identify an activated SCell and/or a serving cell according to the information indicating the configuration of the at least one SCell from the network node.

7. (canceled)

8. The user equipment of claim 3, wherein the transceiver is configured to receive the activation indication through the PDCCH on a serving cell from the network node, the activation indication indicates an activation for the deactivation timer of the at least one SCell, the processor is configured to start or restart the deactivation timer of the at least one SCell according to the activation indication, and the processor is configured to start or restart the deactivation timer of the at least one SCell according to the DCI comprising the activation indication.

9. (canceled)

10. The user equipment of claim 3, wherein the transceiver is configured to receive the deactivation indication through the PDCCH on an activated SCell from the network node, the deactivation indication indicates a deactivation for the deactivation timer of the at least one SCell, the processor is configured to stop the deactivation timer of the at least one SCell according to the deactivation indication, and the processor is configured to stop the deactivation timer of the at least one SCell according to the DCI comprising the deactivation indication.

11. (canceled)

12. The user equipment of claim 3, wherein the transceiver is configured to receive the deactivation indication through the PDCCH on a serving cell from the network node, the deactivation indication indicates a deactivation for the deactivation timer of the at least one SCell, the processor is configured to stop the deactivation timer of the at least one SCell according to the activation indication, and the processor is configured to stop the deactivation timer of the at least one SCell according to the DCI comprising the activation indication.

13. (canceled)

14. A method for controlling a deactivation timer of at least one secondary cell (SCell) of a user equipment, comprising:
receiving a control indication through a physical downlink control channel (PDCCH) from a network node, wherein the control indication indicates control of the deactivation timer of the at least one SCell; and
controlling the deactivation timer of the at least one SCell according to the control indication.

15. The method of claim 14, wherein the PDCCH carries downlink control information (DCI) comprising the control indication, the method comprises controlling the deactivation timer of the at least one SCell according to the DCI.

16. The method of claim 14, wherein the control indication comprises an activation indication and/or a deactivation indication, and the method further comprises receiving information indicating a configuration of the at least one SCell from the network node.

17. (canceled)

18. The method of claim 17, further comprising identifying an activated SCell and/or a serving cell according to the information indicating the configuration of the at least one SCell from the network node.

19. The method of claim 16, further comprising receiving the activation indication through the PDCCH on an activated SCell from the network node, the activation indication indicating an activation for the deactivation timer of the at least one SCell, and restarting the deactivation timer of the at least one SCell according to the activation indication, wherein the method further comprises restarting the deactivation timer of the at least one SCell according to the DCI comprising the activation indication.

20. (canceled)

21. The method of claim 16, further comprising receiving the activation indication through the PDCCH on a serving cell from the network node, the activation indication indicating an activation for the deactivation timer of the at least one SCell, and starting or restarting the deactivation timer of the at least one SCell according to the activation indication, and further comprising: starting or restarting the deactivation timer of the at least one SCell according to the DCI comprising the activation indication.

22. (canceled)

23. The method of claim 16, further comprising receiving the deactivation indication through the PDCCH on an activated SCell from the network node, the deactivation indication indicating a deactivation for the deactivation timer of the at least one SCell, and stopping the deactivation timer of the at least one SCell according to the deactivation indication, and further comprising: stopping the deactivation timer of the at least one SCell according to the DCI comprising the deactivation indication.

24. (canceled)

25. The method of claim 16, further comprising receiving the deactivation indication through the PDCCH on a serving cell from the network node, the deactivation indication indicating a deactivation for the deactivation timer of the at least one SCell, and stopping the deactivation timer of the at least one SCell according to the activation indication, and further comprising stopping the deactivation timer of the at least one SCell according to the DCI comprising the activation indicatio.

26. (canceled)

27. A network node for controlling a deactivation timer of at least one secondary cell (SCell) in a wireless communication system, comprising:
a memory;
a transceiver; and
a processor coupled to the memory and the transceiver,
wherein the processor is configured to:
control the transceiver to notify, to a user equipment, a control indication through a physical downlink control channel (PDCCH), wherein the control indication indicates control of the deactivation timer of the at least one SCell; and
control the deactivation timer of the at least one SCell according to the control indication.

28. The network node of claim 27, wherein the PDCCH carries downlink control information (DCI) comprising the control indication, the processor is configured to control the deactivation timer of the at least one SCell according to the DCI.

29. The network node of claim 27, wherein the control indication comprises an activation indication and/or a deactivation indication, and the transceiver is configured to notify, to the user equipment, information indicating a configuration of the at least one SCell.

30. (canceled)

31. The network node of claim 30, wherein the processor is configured to identify an activated SCell and/or a serving cell according to the information indicating the configuration of the at least one SCell.

32-55. (canceled)
